(19) United States
(12) Patent Application Publication
(10) Pub. No.: US 2012/0317298 A1
(43) Pub. Date: Dec. 13, 2012

(54) SCRIPTING ENVIRONMENT FOR NETWORK DEVICE

(76) Inventor: Martin Gadbois, Laval (CA)

(21) Appl. No.: 13/155,567

(22) Filed: Jun. 8, 2011

(51) Int. Cl. G06F 15/16

(52) U.S. Cl. 709/229

(57) ABSTRACT

A network device includes a controller and a scripting environment. The controller is for controlling a plurality of network devices. The scripting environment is for implementing an interface between the controller and a management system based on a script.

### BACKGROUND

Property management systems may be used by hotel or other property owners, managers, and/or employees to assist in managing a property for business purposes. The property management systems are used for example to keep track of guest names, rooms, minibars, television services, and telephones; to automatically apply charges to a guest's bill; to prepare reports; and to perform other functions useful in managing a property. There are a number of different property management systems available for use. To use a device with a particular property management system, the device needs to be compatible with the particular property management system. A device designed to be compatible with one property management system, however, may not be compatible with other property management systems.

### BRIEF DESCRIPTION OF THE DRAWINGS

FIG. 1 is a block diagram illustrating one example of a system.

FIG. 2 is a block diagram illustrating one example of a controller.

FIG. 3 is a flow diagram illustrating one example of the operation of a controller implementing a script.

FIG. 4 is a flow diagram illustrating one example of a guest lookup operation.

FIG. 5 is a flow diagram illustrating one example of an add charges operation.

FIG. 6 is a flow diagram illustrating one example of an add charges operation for a one way management system.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims.

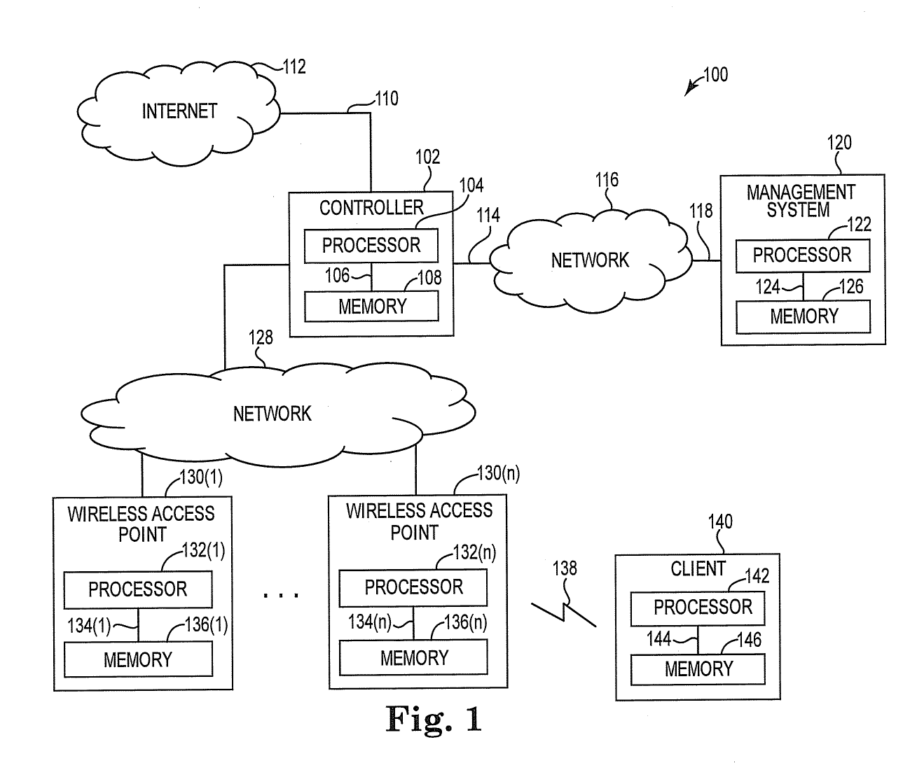

FIG. 1 is a block diagram illustrating one example of a system 100. System 100 includes a controller 102, an internet 112, a network 116, a management system 120, a network 128, wireless access points 130(1)-130(n), where n is any suitable integer, and a client 140. In other examples, system 100 may include any suitable number of controllers 102, wireless access points 130, and clients 140.

In one example, management system 120 is a property management system used by hotel or other property owners, managers, and/or employees to assist in managing a property for business purposes. Management system 120 may be one of any number of different property management systems available for use. Management system 120 communicates with controller 102 for enabling network or internet access for a guest and for applying charges to the guest's account for the network or internet access. To enable compatibility with management system 120, controller 102 includes a scripting environment for running a script that provides an interface to management system 120. A different script is used to interface to different management systems 120. The script may be written and/or edited by the maker of management system 120, the maker of controller 102, the user of property management system 120, or a third party. In this way, controller 102 may be customized to function with any suitable management system 120 by using a different script.

Management system 120 is communicatively coupled to network 116 through communication path 118. Controller 102 is communicatively coupled to network 116 through communication path 114, to internet 112 through communication path 110, and to wireless access points 130(1)-130(n) through network 128. Wireless access point 130(n) is communicatively coupled to client 140 through wireless communication path 138.

Management system 120 is a server or other suitable device capable of executing machine readable instructions for managing a property and interfacing to network devices including controller 102 through network 116. Management system 120 includes a processor 122 and a memory 126. Processor 122 is communicatively coupled to memory 126 through communication path 124. In one example, memory 126 stores instructions executed by processor 122 for operating management system 120. Memory 126 includes any suitable combination of volatile and/or non-volatile memory, such as combinations of random access memory (RAM), read-only memory (ROM), flash memory, and/or other suitable memory.

Network 116 is a local area network, a wide area network, a serial communication link, or other suitable network. Network 128 is a local area network, a wide area network, or other suitable network. In one example, management system 120 is a one way management system, which can receive data from controller 102 through network 116 but cannot send data to controller 102 through network 116. In another example, management system 120 is a two way management system, which can both receive data from controller 102 through network 116 and send data to controller 102 through network 116.

Controller 102 is a network device including an access controller for managing wireless access points 130(1)-130(n). Controller 102 passes communications between internet 112 and network 128. In one example, controller 102 communicates with management system 120 through network 116 to apply charges to a guest's account for internet access and/or to authenticate a guest prior to enabling internet access for the guest. Controller 102 includes a processor 104 and a memory 108. Processor 104 is communicatively coupled to memory 108 through communication path 106. In one example, memory 108 stores instructions executed by processor 104 for operating controller 102. Memory 108 includes any suitable combination of volatile and/or non-volatile memory, such as combinations of RAM, ROM, flash memory, and/or other suitable memory.

Each wireless access point 130(1)-130(n) passes communications between clients, such as client 140, and network 128 through a wireless connection, such as wireless communication path 138. Each wireless access point 130(1)-130(n) includes a processor 132(1)-132(n) and a memory 136(1)-136(n), respectively. Each processor 132(1)-132(n) is communicatively coupled to memory 136(1)-136(n) through a communication path 134(1)-134(n), respectively. In one example, each memory 136(1)-136(n) stores instructions executed by processor 132(1)-132(n) for operating each wireless access point 130(1)-130(n), respectively. Each memory 136(1)-136(n) includes any suitable combination of volatile and/or non-volatile memory, such as combinations of RAM, ROM, flash memory, and/or other suitable memory.

Client 140 is any device capable of communicating with network 128 over a wireless connection, such as a computer (e.g., a laptop or tablet computer), a smartphone, a gaming system, or other suitable computing device. Client 140 includes a processor 142 and a memory 146. Processor 142 is communicatively coupled to memory 146 through communication path 144. In one example, memory 146 stores instructions executed by processor 142 for operating client 140. Memory 146 includes any suitable combination of volatile and/or non-volatile memory, such as combinations of RAM, ROM, flash memory, and/or other suitable memory.

In one example, when client 140 initially connects to wireless access point 130(n), controller 102 performs an authentication process based on information provided by the user of client 140 prior to allowing client 140 access to internet 112. To perform the authentication process, controller 102 queries management system 120 through network 116 for information about the user of client 140. Once controller 102 authenticates the user of client 140, controller 102 grants client 140 access to internet 112. In another example, prior to or after granting client 140 access to internet 112, controller 102 submits a charge for the internet access to the user's account using management system 120. Controller 102 submits the charge to management system 120 through network 116.

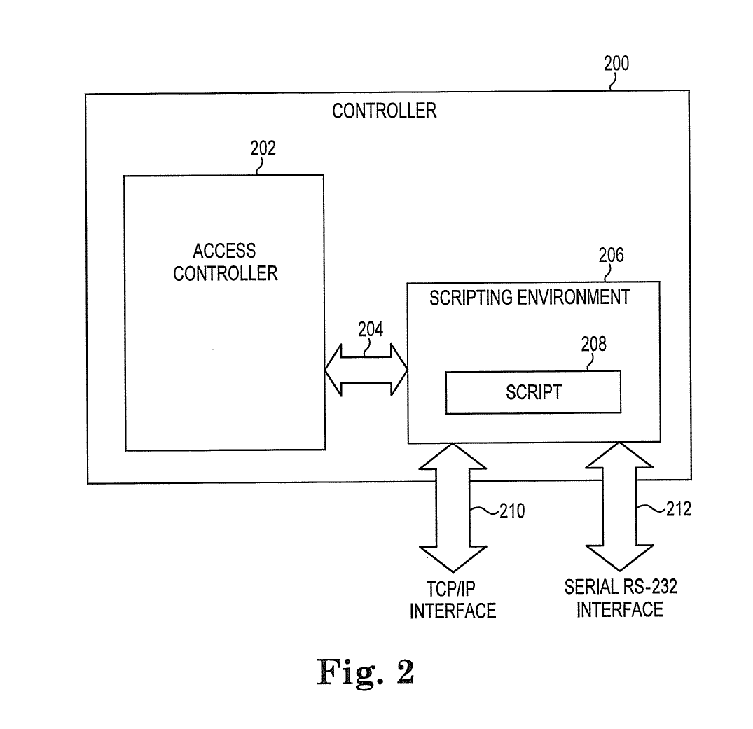

FIG. 2 is a block diagram illustrating one example of a controller 200. In one example, controller 200 provides controller 102 previously described and illustrated with reference to FIG. 1. Controller 200 includes an access controller 202 and a scripting environment 206. In one example, memory, such as memory 108, stores instructions executed by a processor, such as processor 104, for operating access controller 202 and scripting environment 206. Access controller 202 is communicatively coupled to scripting environment 206 through communication link 204. Scripting environment 206 provides an interface between access controller 202 and a management system, such as management system 120 previously described and illustrated with reference to FIG. 1, through a Transmission Control Protocol/Internet Protocol (TCP/IP) interface 210 and/or through a serial RS-232 interface 212. Scripting environment 206 includes a script 208, which defines functions used by access controller 202 to communicate with a management system through TCP/IP interface 210 and/or serial RS-232 interface 212.

Controller 200 provides centralized management and control of wireless access points 130(1)-130(n) (FIG. 1). Controller 200 automates discovery, authentication, and configuration for installed wireless access points 130(1)-130(n). Once authenticated, controller 200 establishes a secure management tunnel for the exchange of configuration and control information with each wireless access point 130(1)-130(n). Controller 200 eliminates time-consuming wireless access point configuration, troubleshooting, and maintenance tasks by providing a single management interface for the entire group of wireless access points 130(1)-130(n) managed by controller 200. In one example, controller 200 automates installation of wireless access point software updates and ensures a consistent set of services are delivered throughout network 128. In one example, all security, Quality of Service (QoS), and other policies may be centrally defined through controller 200 via a secure Web-based management tool.

In one example, scripting environment 206 ensures that no illegal instructions affect the functions of access controller 202 described above. For security, some functionality of access controller 202 is disabled in scripting environment 206. For example, scripting environment 206 prevents script 208 from reading a file. Scripting environment 206 provides TCP/IP interface 210, serial RS-232 interface 212, debugging primitives, and operations for implementing the interface to a management system. In one example, the scripting language used is Lua, which is an embedded scripting language. In one example, scripting environment 206 includes a web interface for exporting, importing, editing, and testing script 208.

Script 208 defines functions for interfacing to a management system. In one example, the functions include a Lookup_Guest(Room_Number, Callback) function, an Add_Charges(Args) function, an Authenticate(Username, Password) function, a Shutdown( ) function, an Rx_Ready( ) function, and a Tick( ) function. In other examples, script 208 includes other suitable functions. Each function is customized within script 208 to interface to a particular management system. Therefore, while scripts written for different management systems may include the same functions, the particular operation of each function may vary based on the management system.

The Lookup_Guest(Room_Number, Callback) function queries the management system for details about the provided “Room_Number.” The “Room_Number” is the room number to look up details about. The details may include the guest's name, whether the guest has been preauthorized for internet access, names of others within the guest's party who have been authorized to use the guest's account, or other suitable details. The provided Callback( ) function is then called with the details about the room from the management system. Access controller 202 may then use the details about the room provided by the management system to allow or deny the guest access to internet 112.

The Add_Charges(Args) function adds charges to a room. In one example, the Args includes “Room_Number,” “Room_GuestName,” “Amount,” and “Callback.” In other examples, the Args include other suitable arguments. The “Room_Number” is the room number to which to add the charge. The “Room_GuestName” is the name that may be registered at the “Room_Number.” The “Amount” is the amount of money that should be charged to the room. In one example, the Add_Charges(Args) function queries the management system. If the provided “Room_GuestName” matches the name that is registered to the provided “Room_Number,” then the charge is accepted and submitted to the management system. If the provided “Room_GuestName” does not match the name that is registered to the provided “Room_Number,” then the charge is rejected. The Callback( ) function is then called with the result of the operation. In other examples, the Add_Charges(Args) function submits the charge to the management system without first querying the management system.

The Authenticate(Username, Password) function authenticates a user based on the provided “Username” indicating the name of the user and the provided “Password” indicating the password for the provided “Username.” The function responds with an indication as to whether the user is authenticated. In one example, the Authenticate(Username, Password) function queries the management system to authenticate the user. In another example, the Authenticate(Username, Password) function authenticates the user without querying the management system.

The Shutdown( ) function is called when the controller wants to shutdown the interface between the controller and the management system. The Rx_Ready( ) function is called when data is ready to be read by script 208. The Tick( ) function is called by the controller at a specified interval and may be used to implement timeouts.

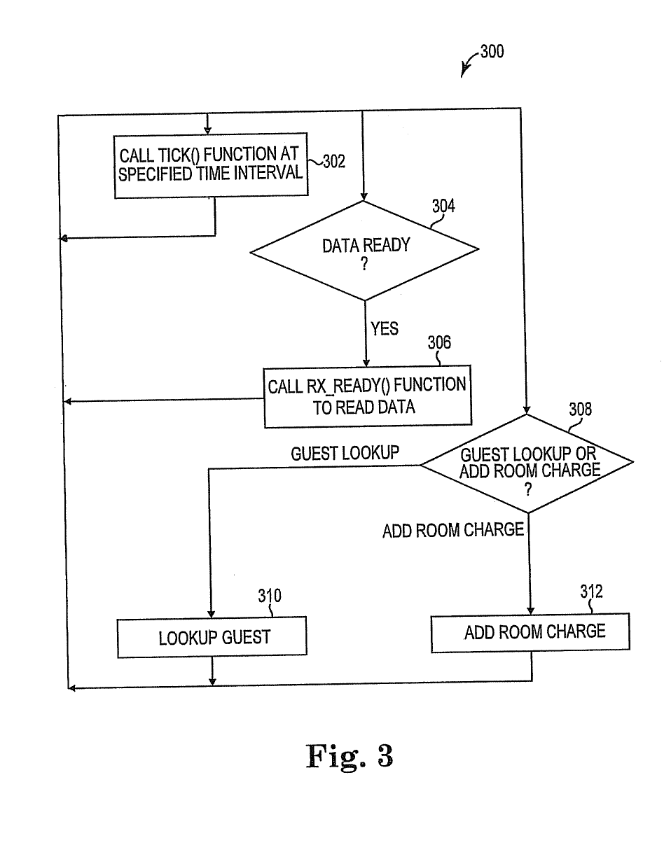

FIG. 3 is a flow diagram illustrating one example of the operation 300 of a controller, such as controller 200 previously described and illustrated with reference to FIG. 2, implementing a script, such as script 208 previously described and illustrated with reference to FIG. 2. At 302, the controller calls the Tick( ) function at a specified time interval. In one example, the Tick( ) function is called once every second. The operation of the Tick( ) function may vary based on the management system. In one example, the Tick( ) function is used to implement timeouts. In other examples, the Tick( ) function provides a keep alive signal to the management system, activates the management system, and/or performs other suitable functions for enabling the interface between the controller and the management system.

At 304, the controller determines whether data is ready. The data may be provided by access controller 202 through communication link 204 (FIG. 2) or by management system 120 through TCP/IP interface 210 or serial RS-232 interface 212. If the data is ready, the controller calls the Rx_Ready( ) function at 306 to read the data.

At 308, the controller determines whether a guest lookup or add room charge operation is to be performed. If a guest lookup operation is to be performed, the controller performs a lookup guest operation at 310. The lookup guest operation queries the management system for information related to a guest to authenticate a guest prior to allowing the guest access to the internet 112 (FIG. 1). If an add room charge is to be performed, the controller performs the add room charge operation at 312. The add room charge operation sends a message including a room number, guest name, and amount to charge to the management system. In other examples, the script may include other suitable functions for querying the management system, receiving information from the management system, and/or sending information to the management system.

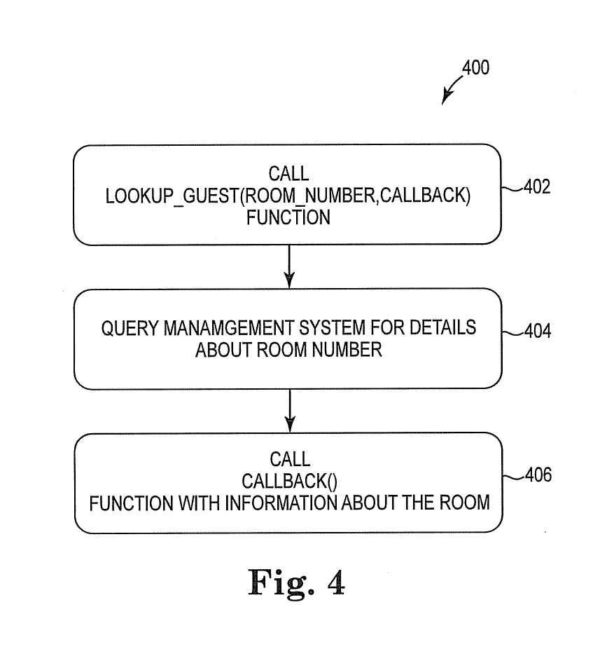

FIG. 4 is a flow diagram illustrating one example of a guest lookup operation 400. At 402, controller 200 (FIG. 2) calls the Lookup_Guest(Room_Number, Callback) function defined by script 208. The operation of the Lookup_Guest function may vary based on the management system. At 404, controller 200 queries the management system for details about the provided room number. At 406, the Callback( ) function is called with information about the room from the management system.

In one example, the information about the room is used to authenticate a guest prior to allowing the guest access to internet 112 (FIG. 1). For example, when a guest (e.g., client 140) initially connects to network 128, controller 200 provides a web page to the client requesting the guest's name and room number. Controller 200 then calls the Lookup_Guest function with the room number provided by the guest. In one example, the Callback function includes the name of the guest registered to the provided room number from the management system. Controller 200 then verifies that the guest name registered to the provided room number from the management system matches the guest name provided by the client prior to authorizing the client access to internet 112.

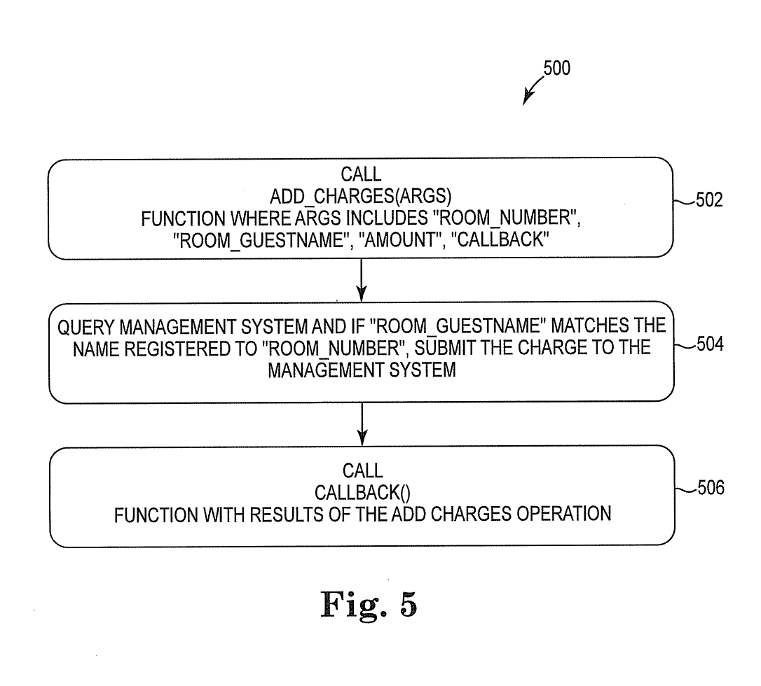

FIG. 5 is a flow diagram illustrating one example of an add charges operation 500. At 502, controller 200 (FIG. 2) calls the Add_Charges(Args) function defined by script 208. The function arguments (Args) include the “Room_Number” for the guest, the “Room_GuestName” for the guest, the “Amount” to be charged to the guest, and the “Callback” function for providing the results of the Add_Charges function. The operation of the Add_Charges function may vary based on the management system. At 504, controller 200 queries the management system to determine if the “Room_GuestName” matches the name registered to the “Room_Number” in the management system. If the “Room_GuestName” matches the name registered to the “Room_Number” in the management system, the “Amount” to charge is submitted to the management system. If the “Room_GuestName” does not match the name registered to the “Room_Number” in the management system, the “Amount” to charge is not submitted to the management system. At 506, the Callback( ) function is called with results of the add charges operation.

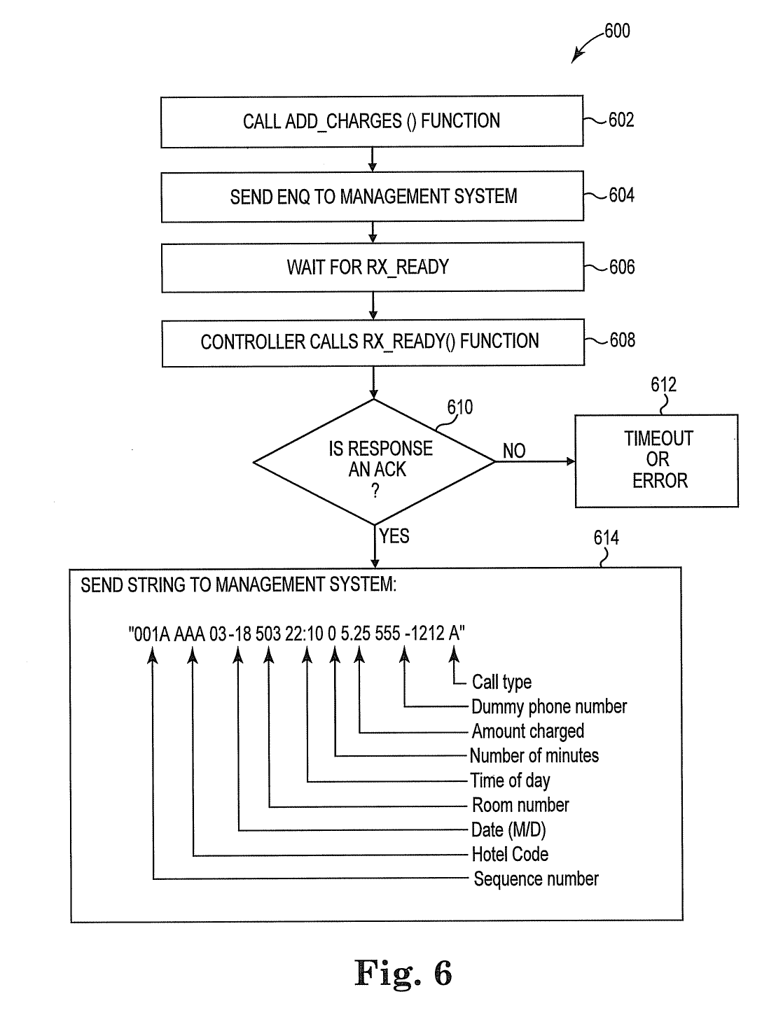

FIG. 6 is a flow diagram illustrating one example of an add charges operation 600 for a one way management system. In one example, the one way management system is a Bell-Hobic property management system. At 602, controller 200 (FIG. 2) calls the Add_Charges( ) function defined by script 208. At 604, controller 200 sends an enquiry (ENQ) to the management system. At 606, controller 200 waits for Rx_Ready. At 608, controller 200 calls the Rx_Ready( ) function to read the response from the management system. At 610, controller 200 determines whether the response from the management system is an acknowledge (ACK). If the response is not an ACK, then at 612 controller 200 times out or indicates an error and the add charges operation ends without adding the changes. In another example, if the response is not an ACK, a retry is attempted by again sending an ENQ to the management system at 604.

If the response from the management system is an ACK, then at 614, controller 200 sends a string to the management system. The example string illustrated in FIG. 6 includes a call type field, a phone number field, an amount charged field, a number of minutes field, a time of day field, a room number field, a date field, a hotel code field, and a sequence number field. Each example field includes example data. The format of the string is customized to the management system by the script in the scripting environment. Other management systems may use other data formats and include different fields that can be set by using an appropriate script for the management system.

Examples provide a controller for managing wireless access points and for interfacing with a management system via a scripting environment. The scripting environment includes a script customized for the management system. The scripting environment enables flexibility since both complex and simple operations may be performed by using a script. The script can be easily modified to meet the needs of the user since the script is accessible to the user. The scripting environment enables a third party to develop a script to access a management system. In addition, the controller does not need to be upgraded to support new or updated management systems. Rather, by changing the script the controller can support new or updated management systems.

Although specific examples have been illustrated and described herein, it will be appreciated by those of ordinary skill in the art that a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

What is claimed is:

1. A network device comprising:
a controller for controlling a plurality of network devices; and
a scripting environment for implementing an interface between the controller and a management system based on a script.

2. The network device of claim 1, wherein the management system comprises a property management system.

3. The network device of claim 1, wherein the controller is for managing a plurality of wireless access points.

4. The network device of claim 3, wherein the script includes a function for authenticating a user of a client connected to one of the wireless access points prior to granting the user access to an internet.

5. The network device of claim 4, wherein the script includes the function for authenticating the user of the client connected to one of the wireless access points by querying the management system prior to granting the user access to the internet.

6. The network device of claim 1, wherein the script includes a function for submitting a charge to an account of a user in the management system.

7. A network device comprising:
a processor; and
a memory communicatively coupled to the processor, the memory storing instructions causing the processor, after execution of the instructions by the processor, to:
manage a plurality of wireless access points including controlling access to a network through the wireless access points; and
provide a scripting environment for interfacing the network device to a management system based on a script.

8. The network device of claim 7, wherein the memory stores instructions causing the processor, after execution of the instructions by the processor, to further:
import, export, or edit the script.

9. The network device of claim 7, wherein the management system comprises a property management system, and
wherein the scripting environment comprises a Transmission Control Protocol/Internet Protocol (TCP/IP) interface and a serial RS-232 interface.

10. The network device of claim 7, wherein the script includes a function for authenticating a user of a client connected to one of the wireless access points by querying the management system prior to granting the user access to the network, and
wherein the script includes a function for submitting a charge to an account of the user in the management system for the access to the network.

11. A method for interfacing a network device to a management system, the method comprising:
providing a scripting environment on a network device, the network device for controlling a plurality of wireless access points; and
executing a script on the network device to interface the network device to a management system.

12. The method of claim 11, wherein executing the script comprises calling a function for authenticating a user of a client connected to one of the wireless access points by querying the management system prior to granting the user access to an internet.

13. The method of claim 11, wherein executing the script comprises calling a function for submitting a charge to an account in the management system of a user of a client connected to one of the wireless access points.

14. The method of claim 11, wherein executing the script comprises communicating with a property management system through one of a Transmission Control Protocol/Internet Protocol (TCP/IP) interface and a serial RS-232 interface.

15. The method of claim 11, further comprising:
importing, exporting, or editing the script in the scripting environment of the network device.
